(19) United States
(12) Patent Application Publication
(10) Pub. No.: US 2023/0034962 A1
(43) Pub. Date: Feb. 2, 2023

(54) PROCESS FOR AMMONIA SYNTHESIS AND PLANT FOR PREPARATION OF AMMONIA

(71) Applicants: thyssenkrupp Industrial Solutions AG, Essen (DE); thyssenkrupp AG, Essen (DE)

(72) Inventors: Bernd KEIL, Dortmund (DE); Bernd MIELKE, Witten (DE); Karan BAGGA, Melbourne (AU)

(73) Assignees: thyssenkrupp Industrial Solutions AG, Essen (DE); thyssenkrupp AG, Essen (DE)

(21) Appl. No.: 17/793,351

(22) PCT Filed: Jan. 13, 2021
(86) PCT No.: PCT/EP2021/050597

§ 371 Date: Jul. 15, 2022

(30) Foreign Application Priority Data
Jan. 27, 2020 (DE) 10 2020 200 905.8

(51) Int. Cl. C01C 1/04; C25B 1/04; C25B 15/08

(52) U.S. Cl. CPC C01C 1/0405; C25B 1/04; C25B 15/081

(57) ABSTRACT

A process for ammonia synthesis in a synthesis circuit may involve circulating a gas mixture comprising nitrogen, hydrogen, and ammonia with a conveying device (2) in the synthesis circuit, reacting nitrogen and hydrogen at least partly to ammonia in a converter, and cooling the gas mixture in a cooling device such that ammonia condenses out of the gas mixture. The disadvantages of adsorption drying and of absorption are avoided as hydrogen and nitrogen are introduced at mutually different sections into the synthesis circuit. The process may also involve introducing nitrogen in a flow direction upstream of the converter and/or directly into the converter in the synthesis circuit.

The invention relates to a process for ammonia synthesis in a synthesis circuit, where a gas mixture comprising nitrogen, hydrogen and ammonia is circulated with a conveying device in the synthesis circuit, where nitrogen and hydrogen are reacted at least partly to ammonia in a converter, and where the gas mixture is cooled in a cooling device such that ammonia condenses out of the gas mixture.

The invention additionally relates to a plant for preparing ammonia in a synthesis circuit, having at least one conveying device for circulating a gas mixture comprising nitrogen, hydrogen and ammonia, having a converter, where nitrogen and hydrogen can be reacted at least partly to ammonia in the converter, and having a cooling device in which the gas mixture can be cooled such that ammonia condenses out of the gas mixture.

In industrial practice, large-scale syntheses that are typically performed as circulation syntheses, when designed as single-stream plants, however, are increasingly meeting limitations due to apparatus, machinery and pipelines. Assuming, for example, a maximum permissible working pressure of about 230 bara in the case of ammonia synthesis, economically viable construction limits for pressure vessels and pipelines are foreseeable. If the intention is to further increase the capacity of circulation syntheses without increasing the number of pressure apparatuses, then technological alterations are necessary.

Ammonia is one of the most important basic chemicals. Worldwide annual production currently runs to about 170 million metric tons. The greatest part of the ammonia is used for producing fertilizers. Present-day industrial production largely uses the high-pressure synthesis developed by Haber and Bosch at the start of the 20th century, in fixed bed reactors with iron as catalytically active main component, based on a synthesis gas with a stoichiometric composition, comprising hydrogen and nitrogen as the main components. The synthesis gas is generated primarily via the natural gas route. A disadvantage here are the large quantities of carbon dioxide obtained.

DE 10 2017 011 601 A1 shows, for example, a process for ammonia synthesis wherein a fresh gas consisting largely of hydrogen and nitrogen is compressed via a compressor and then supplied to an ammonia converter for reaction to give a converter product containing ammonia and comprising hydrogen and nitrogen. Ammonia is then evaporated into the fresh gas upstream of the fresh gas compressor, to cool the fresh gas and generate a cold mixture comprising ammonia and also fresh gas. In a heat exchanger, the mixture is heated against at least one ammonia synthesis process stream to be cooled, and is subsequently compressed via the fresh gas compressor, to give a compressed mixture comprising ammonia and also fresh gas. A stream comprising the fresh gas is supplied, upstream of a circulation cooler, to a gas mixture consisting largely of hydrogen and nitrogen, the constituents of this gas mixture being separated off from the converter product and from the compressed mixture comprising ammonia and also the fresh gas.

In order to make savings in terms of carbon dioxide, consideration has been given to obtaining the raw materials, especially hydrogen, not via the natural gas route. EP 2 589 426 A1, for example, discloses a process for preparing ammonia wherein hydrogen is obtained from the electrolysis of water. Nitrogen may be obtained, for example, from a cryogenic air separation plant. The substances are mixed with one another and compressed to a pressure in the range from 80 to 300 bar.

In ammonia synthesis, the reactants must be free of oxygen and oxygen-containing compounds such as water, for example, since they would otherwise poison the catalyst in the ammonia converter. The hydrogen from the electrolysis is generally saturated with water vapor and also contains up to 0.1 vol % of oxygen. The synthesis circuit is typically supplied with a mixture of hydrogen and nitrogen in a stoichiometric ratio of 3:1, and the water is removed from the reactants (the make-up gas or fresh gas) by adsorption dryers or by absorption of the water in the liquid ammonia formed (the make-up gas or fresh gas).

Both processes have disadvantages. Adsorption drying is complicated, necessitating several adsorbers which must be charged in alternation with the fresh gas and regenerated thermally with a purge gas, which is expensive and complicated. The results are increased capital costs, a time delay for the (re)starting of the plant, and emissions of the purge gas.

Absorption has the disadvantage that the fresh gas must be added before the ammonia condenses out. As a result, the circulation gas is diluted in terms of its ammonia content by the reactants introduced, and so, for a given condensation temperature, less ammonia is separated out of the circulation gas and the ammonia content at the converter entrance is increased relative to the adsorption drying. This leads to a greater circulation quantity in the synthesis circuit and hence to a higher catalyst demand in the converter and an increased driving power of the conveying device. The high-pressure volume of the apparatuses in the synthesis circuit is increased and hence the capital costs are increased as well.

It is therefore an object of the present invention to specify a process and a plant for preparing ammonia wherein the disadvantages of adsorption drying and of absorption are to be avoided, and yet their advantages are to be utilized as far as possible.

This object is initially achieved, by claim 1, in that hydrogen and nitrogen are introduced at mutually different sections into the synthesis circuit. By sections in the synthesis circuit are meant the individual basic operations or the regions between the process steps. Nitrogen and hydrogen may be introduced, for example, into the converter, into the cooling device and/or in the region of the conveying device, into the synthesis circuit. Nitrogen and/or hydrogen may alternatively be introduced in flow direction upstream or downstream, for example, of the converter or of the cooling device into the synthesis circuit. This presupposes that nitrogen and water are available separately and have the requisite purity in relation to the catalyst poisons.

In a first configuration of the invention, nitrogen is introduced in flow direction upstream of the converter and/or directly into the converter into the synthesis circuit. At the entrance to the converter there is then a lower entry concentration of ammonia. It is therefore possible to form more ammonia per pass through the converter, so that the amount of catalyst and amount of circulation gas required are lower. The nitrogen is therefore supplied to the synthesis circuit upstream of the conveying device and ahead of the cooling device. This has a number of advantages in comparison to the process known from the prior art.

In the synthesis circuit, the nitrogen is added after the removal of the ammonia in the cooling device. As a result, the ammonia-containing circulation gas is not diluted with nitrogen before the condensation of the ammonia, and so the condensation of the ammonia takes place at higher partial pressures and there is a lower entry concentration of ammonia at the entrance to the converter. It is therefore possible to form more ammonia per pass through the converter, and hence the amount of catalyst and amount of circulation gas required are lower than if the nitrogen is added together with the hydrogen ahead of the ammonia separation. The conveying device, which may be a circulator, for example, therefore circulates a smaller quantity of gas.

It is possible, furthermore, to divide the cold gaseous nitrogen over possible individual catalyst beds of the converter. As a result, the exit temperature of the individual catalyst bed can be controlled not only by admixing of cold quench gas but also by establishing the ratio of hydrogen and nitrogen to one another at each bed entry. In this way the reaction rate can be controlled as well.

In a further configuration of the process of the invention, hydrogen is introduced in flow direction upstream of the cooling device into the synthesis circuit. This has the advantage that water contained in the hydrogen dissolves in the ammonia which condenses out, and is removed with the liquid product ammonia from the synthesis circuit. Separate drying of the fresh gas and/or hydrogen, with the associated expenditure in financial and apparatus terms, and also the time-consuming and emissions-entailing regeneration of the adsorption dryers customary in the prior art, are therefore not needed.

In accordance with a further configuration of the invention, hydrogen can be provided by means of electrolysis of water. The electrolysis of water does not produce high-purity hydrogen. Instead, water or water vapor remains, and must be separated from the hydrogen. By introducing the hydrogen downstream of the converter and upstream of the cooling device, the water can be absorbed by the ammonia and can condense out with the ammonia in the cooling device. In this way there is no need for a costly and inconvenient adsorption apparatus.

Against the background of the increasingly pressing climate problem, the chemical industry is among those calling for reductions in carbon dioxide emissions. One of the provisions for this in the process of the invention is that the energy needed for the electrolysis is obtained from renewable energies. Renewable energies or regenerative energies are energy sources which on the human time horizon are available virtually inexhaustively or which are relatively rapidly renewed. They include, for example, solar energy, geothermal energy or energy from biomass.

Generally in the process of the invention the stoichiometric ratio of introduced hydrogen to nitrogen is 3:1. Owing to the possibly fluctuating electrolysis which is operated with renewable energies, it is possible, in one configuration of the process of the invention, for the ratio of hydrogen to nitrogen to be regulated if the hydrogen supply becomes lower, with the ratio of hydrogen to nitrogen being in the range of 0.95 to 1. In this way the process can be operated further even if the hydrogen production falls back. If the hydrogen production rises again, the hydrogen to nitrogen ratio can be slowly brought back to standard value—that is, to a stoichiometric ratio of hydrogen to nitrogen of 3:1—by increasing the hydrogen feed into the synthesis circuit. This technique prevents frequent starting and stopping of the plant in which the process is operated, in the event of fluctuating or absent hydrogen production by the electrolysis, should the renewable energy sources fluctuate.

In a further configuration of the process of the invention, hydrogen is compressed before being introduced into the synthesis circuit. In this case the hydrogen from the electrolysis is compressed separately, so that the end stages of the corresponding compressor are required to compress a lower volume flow than if hydrogen and nitrogen are jointly compressed and supplied to the synthesis circuit. The compressor therefore also requires a lower driving power.

The aforesaid object is also achieved by a plant for producing ammonia in a synthesis circuit, having at least one conveying device for circulating a gas mixture comprising nitrogen, hydrogen and ammonia, having a converter, where nitrogen and hydrogen can be reacted at least partially to ammonia in the converter, and having a cooling device in which the gas mixture can be cooled such that ammonia condenses out of the gas mixture. This plant is characterized in that hydrogen and nitrogen can be introduced at mutually different sections into the synthesis circuit.

The observations made regarding the process of the invention are also valid correspondingly for the plant of the invention.

According to a first configuration of the plant of the invention, nitrogen can be introduced in flow direction upstream and/or in flow direction downstream of the converter into the synthesis circuit. At the entrance of the converter there is then a lower entry concentration of ammonia present. It is therefore possible for more ammonia to be formed per pass through the converter, and so the amount of catalyst and amount of circulation gas required are lower. The nitrogen is therefore supplied to the synthesis circuit upstream of the conveying device and ahead of the cooling device.

In a further configuration of the plant of the invention, hydrogen can be introduced in flow direction upstream of the cooling device into the synthesis circuit. Upstream of the cooling device also means downstream of the converter. Hence any water contained in the hydrogen can be dissolved in the ammonia formed and is condensed out together with the ammonia in the cooling device.

Correspondingly at least one electrolysis cell is provided for producing the hydrogen. The hydrogen required is provided, accordingly, by the electrolysis of water.

In detail there are a multiplicity of possibilities for the configuration and development of the process of the invention and the plant of the invention. Reference is made in this regard both to the claims subordinate to claims 1 and 10, and to the description hereinafter of preferred exemplary embodiments in conjunction with the drawing. In the drawing

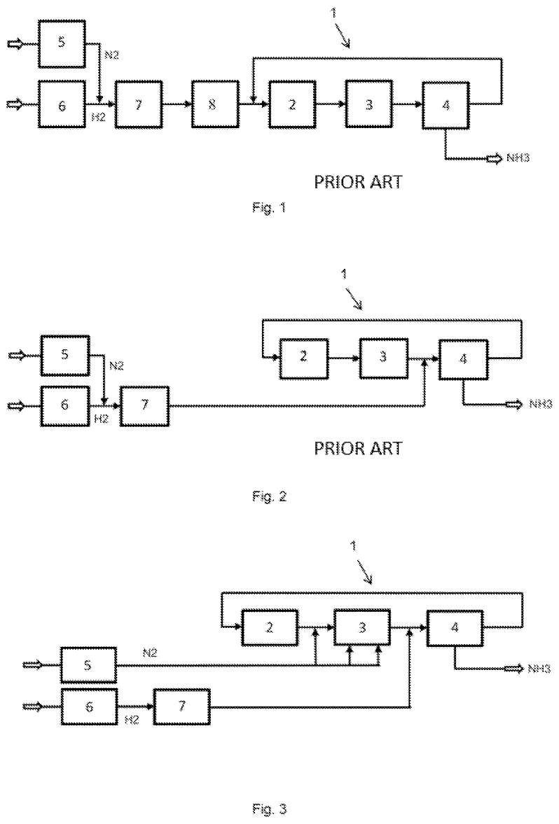

FIG. 1 shows a schematic representation of a process known from the prior art for preparing ammonia, with drying of the fresh gas;

FIG. 2 shows a further schematic representation of a process known from the prior art for preparing ammonia, with scrubbing of the fresh gas; and

FIG. 3 shows a schematic representation of a process of the invention for preparing ammonia.

FIG. 1 shows a process known from the prior art for preparing ammonia NH3 in a synthesis circuit 1. The anhydrous fresh gas introduced is mixed with the circulation gas by means of conveying device 2 in the synthesis circuit 1. For the reaction of hydrogen H2 and nitrogen N2, a converter 3 is provided. In the converter 3, hydrogen H2 and nitrogen N2 react to form ammonia NH3. After the reaction in the converter 3, the gas mixture, consisting of hydrogen H2, nitrogen N2 and ammonia NH3, is passed into a cooling device 4. In the cooling device 4, the gas mixture is cooled to an extent such that ammonia NH3 condenses and can be separated in liquid form. The reacted reactants hydrogen H2 and nitrogen N2, and also the uncondensed ammonia NH3, are run back to the conveying device 2 in the synthesis circuit 1. The conveying device may be a pump or a circulator.

The nitrogen N2 needed for the ammonia synthesis is supplied in high-purity gas form by a nitrogen provision 5. The hydrogen H2 likewise needed is generated by electrolysis 6 of water. The power needed for these purposes is obtained from fluctuating renewable energies. Accordingly, the power consumption of the electrolyzer can be reduced in this case to 20% of the nominal power.

Hydrogen H2 and nitrogen N2 are mixed and jointly compressed to the synthesis pressure in a compressor 7. The water present is removed by means of molecular sieves in an adsorption dryer 8.

Adsorption drying is costly and inconvenient, since for the adsorption dryer a plurality of adsorbers are required, which must be charged alternately with the gas mixture and alternately regenerated with a purge gas, thermally, which is costly and inconvenient.

FIG. 2 shows a further process known from the prior art for preparing ammonia NH3 in a synthesis circuit 1. On scrubbing of the gas mixture, consisting of the unprocessed nitrogen N2 and hydrogen H2, with ammonia NH3 obtained from condensation, the compressed gas mixture (also called fresh gas) still containing water is supplied to the synthesis circuit 1 ahead of the cooling device 4. The absorption drying in the liquid ammonia NH3 formed has the advantage of operating without additional apparatus for drying the fresh gas. It has the disadvantage, however, that the addition of fresh gas must be made before the condensation of the ammonia NH3. As a result, the circulation gas is diluted in terms of its ammonia content by the reactants introduced, and so, for a given condensation temperature, less ammonia is separated from the circulation gas and the ammonia content at the entrance of the converter 3 is increased relative to adsorption drying. This leads to a higher circulation quantity and hence to a higher catalyst requirement in the converter 3 and an increased driving power on the part of the conveying device 2.

FIG. 3 shows a schematic representation of the process of the invention or plant of the invention for producing ammonia NH3. The nitrogen N2 is supplied in high purity, free from oxygen and oxygen-containing compounds, by the nitrogen provision 5. The nitrogen N2 is passed in flow direction upstream of, and also directly into, the converter 3. At the entrance to the converter 3, there is then a comparatively low entry concentration of ammonia NH3 present. Accordingly more ammonia NH3 can be formed per pass through the converter 3, and so the amount of catalyst and amount of circulation gas required are lower, as compared with the simultaneous addition of hydrogen H2 and nitrogen N2.

The hydrogen H2 from the electrolysis 6 is compressed separately with a compressor 7, and so the end stages of the compressor 6 are required to compress a lower volume flow than if hydrogen H2 and nitrogen N2 are jointly compressed and supplied to the synthesis circuit 1.

The hydrogen H2, compressed to about 261 bara, is added to the circulation gas upstream of the cooling device 4. This has the advantage that the water contained in the hydrogen H2 dissolves in the condensing ammonia NH3 and is removed from the synthesis circuit 1 with the liquid ammonia NH3. Separate drying of the fresh gas, with the associated expenditure in financial and apparatus terms, and also the time-consuming and emissions-entailing regeneration of the adsorption dryers 8, are therefore no longer necessary.

The minimum hydrogen H2 to nitrogen N2 ratio for the supply to the converter is set at about 1, allowing the partial load range of the converter 3 to be reduced further, without the reaction coming to a standstill. This is particularly advantageous, as it allows autothermal behavior of the reaction, without external heating, when the hydrogen supply is low.

If hydrogen production rises again, the hydrogen H2 to nitrogen N2 ratio can be slowly brought back to normal value by increasing the water feed into the synthesis circuit 1. This technique prevents frequent starting/stopping of the plant when hydrogen production by the electrolysis 6 is fluctuating or absent, if the electrolysis 6 is driven by renewable energies and these energy sources fluctuate.

### LIST OF REFERENCE SYMBOLS

(1) Synthesis circuit
(2) Conveying device
(3) Converter
(4) Cooling device
(5) Nitrogen provision
(6) Electrolysis
(7) Compressor
(8) Adsorption dryer

1.-12. (canceled)

13. A process for ammonia synthesis in a synthesis circuit, the process comprising:
circulating a gas mixture comprising nitrogen, hydrogen, and ammonia with a conveying device in the synthesis circuit;
reacting nitrogen and hydrogen at least partially to ammonia in a converter;
cooling the gas mixture in a cooling device such that ammonia condenses out of the gas mixture,
wherein hydrogen and nitrogen are introduced at mutually different sections into the synthesis circuit.

14. The process of claim 13 comprising introducing nitrogen in a flow direction upstream of the converter and/or directly into the converter in the synthesis circuit.

15. The process of claim 13 comprising introducing hydrogen in a flow direction upstream of the cooling device into the synthesis circuit.

16. The process of claim 13 comprising providing hydrogen by way of electrolysis of water.

17. The process of claim 16 comprising obtaining energy needed for the electrolysis from renewable energies.

18. The process of claim 13 wherein a stoichiometric ratio of introduced hydrogen to nitrogen is 3:1.

19. The process of claim 13 comprising regulating a ratio of hydrogen to nitrogen when a supply of hydrogen becomes lower.

20. The process of claim 19 wherein the ratio of hydrogen to nitrogen is 3.

21. The process of claim 19 wherein the ratio of hydrogen to nitrogen is 0.95.

22. The process of claim 13 comprising compressing hydrogen before introducing the hydrogen into the synthesis circuit.

23. A plant for preparing ammonia in a synthesis circuit, the plant comprising:
a conveying device configured to circulate a gas mixture comprising nitrogen, hydrogen, and ammonia in the synthesis circuit, with the synthesis circuit being configured such that hydrogen and nitrogen are introducible at mutually different sections into the synthesis circuit;
a converter configured to react nitrogen and hydrogen at least partly to ammonia in the converter; and
a cooling device configured to cool the gas mixture such that ammonia condenses out of the gas mixture.

24. The plant of claim 23 comprising means for introducing nitrogen in a flow direction upstream of the converter into the synthesis circuit.

25. The plant of claim 23 comprising means for introducing nitrogen in a flow direction downstream of the converter into the synthesis circuit.

26. The plant of claim 23 comprising means for introducing hydrogen in a flow direction upstream of the cooling device into the synthesis circuit.

27. The plant of claim 23 comprising an electrolysis cell configured to provide hydrogen by electrolysis of water.
